(19) United States
(12) Patent Application Publication
(10) Pub. No.: US 2021/0301860 A1
(43) Pub. Date: Sep. 30, 2021

(54) TOOLLESS BOLT AND RATCHETING NUT SET

(71) Applicant: Ryan O. Humbert, East Northport, NY (US)

(72) Inventor: Ryan O. Humbert, East Northport, NY (US)

(21) Appl. No.: 16/833,567

(22) Filed: Mar. 28, 2020

(51) Int. Cl. F16B 39/12; F16B 39/32

(52) U.S. Cl. CPC F16B 39/12; F16B 39/32

(57) ABSTRACT

A system a for providing a toolless bolt and ratcheting nut set is disclosed. The bolt and ratcheting nut set provide an easily and quickly connecting bolt and ratcheting nut combination that provides a secure coupling of the components without the need for separate hand tools.

### TECHNICAL FIELD

This application relates in general to a system for providing a toolless bolt and ratcheting nut set, and more specifically, to a system for providing an easily and quickly connecting bolt and ratcheting nut combination that provides a secure coupling of the components without requiring the use of separate hand tools.

### BACKGROUND

Situations arise in which objects need to be held in place in which it is either difficult, or at least inconvenient, to have hand tools within reach to use restraining mechanisms such as ratcheting nuts and bolts. These situations may arise when workers cannot physically access the work location with their hand tools or the work area itself is so small that hand tools cannot easily reach the part or place that requires a ratcheting nut/bolt coupling.

Therefore, a need exists for an easily and quickly connecting bolt and ratcheting nut combination that provides a secure coupling of the components without requiring the need for separate hand tools.

### SUMMARY

In accordance with the present invention, the above and other problems are solved by providing a system for an easily and quickly connecting bolt and ratcheting nut combination that provides a secure coupling of the components without requiring the need for separate hand tools according to the principles and example embodiments disclosed herein.

In one embodiment, the present invention is a system for providing an easily and quickly connecting bolt and ratcheting nut combination that provides a secure coupling of the components without requiring the need for separate hand tools.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for a system that provides toolless bolt and ratcheting nut set according to the present invention.

FIG. 2 illustrates a cross-section view of a ratcheting nut engaging a bolt within a system for providing an easily and quickly connecting bolt and ratcheting nut combination that provides a secure coupling of the components without requiring the need for separate hand tools according to the present invention.

### DETAILED DESCRIPTION

This application relates in general a system for providing a toolless bolt and ratcheting nut set, and more specifically, to a system for providing an easily and quickly connecting bolt and ratcheting nut combination that provides a secure coupling of the components without requiring the need for separate hand tools according to the present invention.

An embodiment of the present invention will be described in detail with reference to the drawings, wherein like reference numerals represent like parts and assemblies throughout the views. Reference to this embodiment does not limit the scope of the invention, which is limited only by the scope of the claims attached hereto. Additionally, any example set forth in this specification is not intended to be limiting and merely sets forth one of the many possible embodiments for the claimed invention.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The terms “worker” and “user” refer to an entity, e.g. a human, using a toolless bolt and ratcheting nut set associated with the invention. The term user herein may refer to one or more users.

The term “invention” or “present invention” refers to the invention being applied for via the patent application with the title “Toolless Bolt and Ratcheting Nut Set.” Invention may be used interchangeably with “Quick Bolt.”

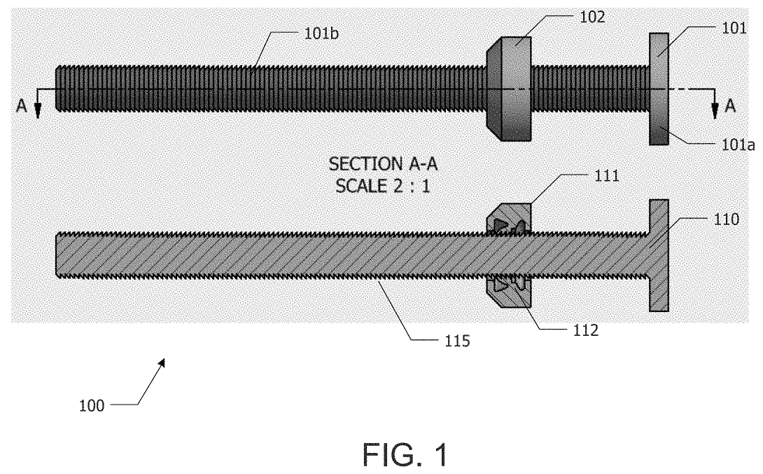

In general, the present disclosure relates a system for providing an easily and quickly connecting bolt and ratcheting nut combination that provides a secure coupling of the components without requiring the need for separate hand tools. To better understand the present invention, FIG. 1 illustrates an example embodiment for a system 100 for providing a toolless bolt and ratcheting nut set according to the present invention. FIG. 1 shows a complete bolt 101 and corresponding ratcheting nut 102 connected together according to the present invention.

FIG. 1 also shows a cross-section view of the bolt 110 and a cross-section view 111 of the ratcheting nut engaging each other according to the present invention. The bolt and ratcheting nut may be made from any resilient material such as metal, plastic, synthetic polymer or similar material depending upon a level holding force needed for use of the bolt and ratcheting nut set. The bolt consists of a bolt head 101a and a shaft 101b. A set of connection teeth 115 directed upwards towards the bolt head 101a are located equally spaced along the shaft 101b.

The ratcheting nut 102 engages the set of connection teeth 115 as the ratcheting nut us pushed along the length of the shaft 102 from its open end toward the bolt head. The ratcheting nut 102 comprises a ratcheting nut body and a connection arm 112 containing a set of engagement grooves 117 along a through hole having an inner diameter within the ratcheting nut 102. The ratcheting nut 102 may be readily pushed along the shaft 101b toward the bolt head 101a causing the set of connection teeth 115 to engage the set of engagement grooves 117. The orientation of the set of connection teeth 115 and the set of engagement grooves 117 permits the ratcheting nut 102 to easily move inward as the set of connection teeth 115 moves through the set of engagement grooves 117. The ratcheting nut 102 may be pushed inward as it engages with an object (not shown) to be held in place by the bolt and ratcheting nut set.

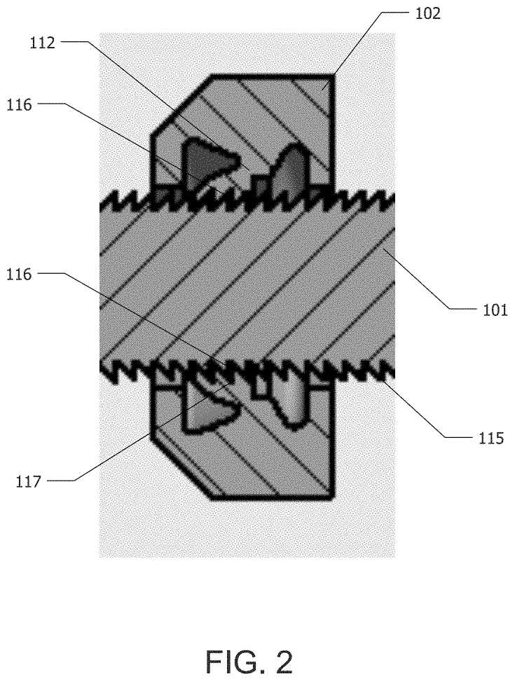

FIG. 2 illustrates a cross-section view of a ratcheting nut engaging a bolt within a system for providing an easily and quickly connecting bolt and ratcheting nut combination that provides a secure coupling of the components without requiring the need for separate hand tools according to the present invention. As noted above, the orientation of the set of connection teeth 115 and the set of engagement grooves 117 permits the ratcheting nut 102 to easily move inward as the set of the connection teeth 115 moves through the set of engagement grooves 117. This same orientation makes it difficult, if not impossible, for the ratcheting nut 101 to be removed once it has been placed onto the bolt 101. The upward pointing orientation of the set of connection teeth 115 causes two or more of the connection teeth 116 to directly engage with an equal number of connection grooves 117 to hold the ratcheting nut 102 in place. The shape of the teeth and grooves are slanted in a direction that prevents the teeth from releasing its position within the corresponding grooves should the ratcheting nut encounter a force pushing it away from the bolt head 101.

The fact that the two or more connection teeth 116 cannot easily be dislodged from their corresponding connection grooves 117 results in the ratcheting nut 102 being permanently installed once it has been placed onto the bolt 101. This same force, however, that prevents a user from removing the ratcheting nut 102 from the bolt 101 also resists any force created by the object (not shown) that is being held in place by the bolt and ratcheting nut set. Items secured by the bolt 102 passing through the object and being restrained by the ratcheting nut 102 will likely remain in place with the use of the present invention.

Even though a particular combination of features is recited in the present application, this combination is not intended to limit the disclosure of the invention. In fact, many of these features may be combined in ways not specifically recited in this application. In other words, any of the features mentioned in this application may be included in this new invention in any combination or combinations to allow the functionality required for the desired operations.

What is claimed is:

1. A system for providing a toolless bolt and ratcheting nut set, the system comprising:
a bolt comprising a bolt head and a shaft having a length and a shaft diameter, the shaft comprises a set of connection teeth equally spaced along the length of the shaft; and
a ratcheting nut having a through hole having an inner diameter matching the shaft diameter, the ratcheting nut comprises a nut body and a connection arm containing a set of connection grooves equally space along the through hole;
wherein the connection teeth and the connection grooves are oriented to engage each other permitting movement of the ratcheting nut along the shaft towards the bolt head and preventing movement of the ratcheting nut along the shaft away from the bolt head.

2. The system according to claim 1, wherein the two or more connection teeth engage an corresponding number of connection grooves.

3. The system according to claim 2, wherein the bolt is made of metal.

4. The system according to claim 3, wherein the ratcheting nut is made of metal.

5. The system according to claim 2, wherein 3 the bolt and the ratcheting nut are made of a synthetic polymer.
